(19) United States
(12) Patent Application Publication
(10) Pub. No.: US 2006/0055160 A1
(43) Pub. Date: Mar. 16, 2006

(54) Inflator having a fluid

(75) Inventors: Fred J. Cook, Gilbert, AZ (US); George W. Goetz, Fountain Hills, AZ (US); Brian R. Pitstick, Mesa, AZ (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/942,569

(22) Filed: Sep. 16, 2004

(51) Int. Cl. B60R 21/26

(52) U.S. Cl. 280/741

(57) ABSTRACT

An inflator (10) includes a container (12) having a fluid storage chamber (70) and an exit passage (64). A fluid (80) is stored in the chamber (70). The fluid (80), when heated beyond a predetermined temperature, undergoes one of combustion, thermal decomposition, or a change of state to result in inflation fluid. An igniter (82) of the inflator (10), when actuated, heats the fluid (80) beyond the predetermined temperature. The inflator (10) also includes structure (110) that is located within the chamber (70) for limiting the flow of the fluid through the exit passage (64) of the container (12) prior to being heated beyond the predetermined temperature.

### TECHNICAL FIELD

The present invention relates to an inflator, and particularly to an inflator for use in inflating an inflatable vehicle occupant protection device.

### BACKGROUND OF THE INVENTION

A known inflator for inflating an inflatable vehicle occupant protection device includes a container having a storage chamber. A rupturable burst disk closes a flow passage that extends through an end of the container. A fluid, which can be a combustible gas mixture, is stored under pressure within the storage chamber. An igniter is attached to the container. The igniter is actuatable for heating the fluid within the storage chamber to supply inflation fluid. As the fluid is heated, the pressure within the storage chamber increases. The increased pressure within the chamber ruptures the burst disk to enable the flow of inflation fluid out of the storage chamber of the inflator.

In an inflator utilizing a combustible gas mixture, the combustible gas mixture is combusted to produce, among other things, heat. To help minimize the amount of uncombusted fuel gas leaving the inflator, a high burn efficiency is desired. Achieving a high burn efficiency is more difficult when the igniter and the burst disk are located at opposite ends of the inflator. When the igniter and the burst disk are located at opposite ends of the inflator, the combustible gas mixture tends to flow toward the exit opening and away from a heating zone produced by the igniter after the burst disk has been ruptured. As a result, the inflation fluid exiting the inflator may include a high concentration of uncombusted fuel gas from the combustible gas mixture.

### SUMMARY OF THE INVENTION

The present invention relates to an inflator comprising a container having a fluid storage chamber and an exit passage. A fluid is stored in the chamber. The fluid, when heated beyond a predetermined temperature, undergoes one of combustion, thermal decomposition, or a change of state to result in inflation fluid. An igniter, when actuated, heats the fluid beyond the predetermined temperature. The inflator also includes structure within the chamber for limiting the flow of the fluid through the exit passage of the container prior to being heated beyond the predetermined temperature.

According to another aspect, the present invention relates to an inflator. The inflator comprises a container having a fluid storage chamber. The chamber includes opposite first and second ends. An exit passage is located at the second end of the container. A fluid is stored in the chamber. The fluid, when heated beyond a predetermined temperature, undergoes one of combustion, thermal decomposition, or a change of state to result in an inflation fluid. The inflator also includes structure within the chamber for limiting the flow of the fluid through the exit passage of the container prior to being heated beyond the predetermined temperature. The structure includes first and second ends. The first end of the structure is connected with the container. The structure divides the chamber into first and second chamber portions. The second chamber portion is located in a flow path between the first chamber portion and the exit passage. An igniter, when actuated, produces a heating zone in the second chamber portion. The fluid passing through the heating zone is heated beyond the predetermined temperature. The fluid within the first chamber portion passes through the heating zone prior to exiting the chamber through the exit passage.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a sectional view of an inflator constructed in accordance with a first embodiment of the present invention;

FIG. 2 illustrates the inflator of FIG. 1 after actuation of an igniter of the inflator and prior to rupturing of a burst disk of the inflator;

FIG. 3 illustrates the inflator of FIG. 1 after the rupturing of the burst disk;

FIG. 4 illustrates a sectional view of an inflator constructed in accordance with a second embodiment of the present invention.

FIG. 5 illustrates the inflator of FIG. 4 in an actuated condition;

FIG. 6 illustrates a sectional view of an inflator constructed in accordance with a third embodiment of the present invention; and

FIG. 7 illustrates the inflator of FIG. 6 in an actuated condition.

### DESCRIPTION OF PREFERRED EMBODIMENT

FIG. 1 is a sectional view of an inflator 10 constructed in accordance with a first embodiment of the present invention. The inflator 10 includes a container 12 having axially opposite first and second ends 14 and 16, respectively.

The container 12 includes tubular body portion 22, an igniter endcap 24, and a diffuser endcap 26. The body portion 22 includes cylindrical inner and outer surfaces 30 and 32, respectively. Both of the inner and outer surfaces 30 and 32 are centered on axis A. The body portion 22 also includes first and second open ends 34 and 36, respectively. The first open end 34 is located near the first end 14 of the container 12 and the second open end 36 is located near the second end 16 of the container.

The igniter endcap 24 includes a cylindrical outer surface 40 and first and second radially extending side surfaces 42 and 44, respectively. The cylindrical outer surface 40 is centered on axis A and has a diameter that is approximately equal to the diameter of the outer surface 32 of the body portion 22. The second side surface 44 of the igniter endcap 24 is fixed to the first open end 34 of the body portion 22. Preferably, the second side surface 44 of the igniter endcap 24 is welded to the first open end 34 of the body portion 22.

A stepped aperture 46 extends axially through the igniter endcap 24. The stepped aperture 46 is centered on axis A and includes a wide portion 48 and a narrow portion 50. The wide portion 48 of the stepped aperture 46 is located adjacent the first side surface 42 of the igniter endcap 24. The narrow portion 50 of the stepped aperture 46 is connected with the wide portion 48 near the center of the igniter endcap 24. The narrow portion 50 extends to the second side surface 44 of the igniter endcap 24 and terminates at a circular opening 52 located on the second side surface 44 of the igniter endcap 24.

The igniter endcap 24 includes a plurality of retaining tabs 54. Two of the retaining tabs 54 are shown in FIG. 1. Each retaining tab 54 may be bent from a position extending axially outwardly of the first side surface 42 of the igniter endcap 24 to a position extending radially into the wide portion 48 of the stepped aperture 46 adjacent the first side surface 42 of the igniter endcap 24, as is shown in FIG. 1.

The diffuser endcap 26 includes a cylindrical outer surface 58 and first and second radially extending side surfaces 60 and 62, respectively. The cylindrical outer surface 58 is centered on axis A and has a diameter that is approximately equal to the diameter of the outer surface 32 of the body portion 22. The first side surface 60 of the diffuser endcap 26 is fixed to the second open end 36 of the body portion 22. Preferably, the first side surface 60 of the diffuser endcap 26 is welded to the second open end 36 of the body portion 22.

An exit passage 64 extends axially through the diffuser endcap 26 from the first side surface 60 to the second side surface 62. The exit passage 64 is centered on axis A. A cylindrical surface 66 of the diffuser endcap 26 defines the exit passage 64. The exit passage 64 forms circular opening on the first side surface 60 of the diffuser endcap 26.

A fluid storage chamber 70 is located within the container 12. The chamber 70 has an axial length that is defined along axis A between the second side surface 44 of the igniter endcap 24 and the first side surface 60 of the diffuser endcap 26. A first end 72 of the chamber 70 is located adjacent the igniter endcap 24 and a second end 74 is located adjacent the diffuser endcap 26. The exit passage 64 communicates with the second end 74 of the chamber 70. The inner surface 30 of the body portion 22 of the container 12 defines the radially outer extent of the chamber 70.

A fluid is stored in the fluid storage chamber 70. The fluid in the inflator 10 of FIG. 1 is a combustible mixture of gasses 80. The combustible gas mixture 80 is stored under pressure in the fluid storage chamber 70. The combustible gas mixture 80 preferably includes an inert gas, hydrogen, and oxygen or hydrogen and air. Trace amounts of helium may be added to the combustible gas mixture 80 to aid in leak detection. When heated beyond a predetermined temperature, the combustible gas mixture 80 combusts. Combustion of the combustible gas mixture 80 heats the inert gas. The heated inert gas is the inflation fluid.

As an alternative to the combustible gas mixture 80, the fluid may be a combustible liquid that is combusted when heated beyond the predetermined temperature or a liquid that experiences gasification upon being heated beyond a predetermined temperature. A refrigerant, for example, Freon, is an exemplary liquid that experiences gasification when heated beyond a predetermined temperature. As a further alternative, the fluid may undergo decomposition when heated beyond the predetermined temperature. Nitrous oxide is an exemplary gas that undergoes decomposition when heated beyond a predetermined temperature.

The inflator 10 also includes an actuatable igniter 82. The igniter 82 includes an actuatable portion 84 and a support portion 86. The actuatable portion 84 contains a pyrotechnic material (not shown) and a resistive wire (not shown) for igniting the pyrotechnic material. The support portion 86 is wider in diameter, relative to axis A, than the actuatable portion 84 and includes opposite end surfaces 88 and 90, respectively, for engaging portions of the igniter endcap 24. Leads 92 of the igniter 82 extend away from the support portion 86 in a direction opposite the actuatable portion 84. The leads 92 enable the igniter 82 to be connected to electronic circuitry (not shown) of a vehicle safety system (not shown).

The igniter endcap 24 supports the igniter 82. The igniter 82 is inserted into the stepped aperture 46 of the igniter endcap 24 from the first side surface 42. When inserted into the stepped aperture 46, the actuatable portion 84 of the igniter 82 is located in the narrow portion 50 of the stepped aperture 46 and the support portion 86 of the igniter is located in the wide portion 48 of the stepped aperture. The retaining tabs 54 of the igniter endcap 24 secure the igniter 82 in the stepped aperture 46.

The inflator 10 also includes two metal burst disks 98 and 100. The burst disk 98 closes the opening 52 on the second side surface 44 of the igniter endcap 24. The burst disk 100 closes the exit passage 64 of the diffuser endcap 26. The burst disk 100 has a domed central portion 102 and a radially outwardly extending flange portion 104. The flange portion 104 of the burst disk 100 is affixed to the first side surface 60 of the diffuser endcap 26. Preferably, the flange portion 104 of the burst disk 100 is welded to the first side surface 60. When the flange portion 104 of the burst disk 100 is affixed to the first side surface 60 of the diffuser endcap 26, the domed central portion 102 of the burst disk 100 closes the exit passage 64 so as to prevent the combustible gas mixture 80 from exiting the chamber 70 through the exit passage 64. The domed central portion 102 of the burst disk 100 is designed to rupture when subjected to a pressure differential of a predetermined amount.

The inflator 10 also includes a conduit 110 that is located within the chamber 70 of the container 12. The conduit 110 is axially elongated and generally tubular. The conduit 110 includes opposite first and second ends 112 and 114, respectively. The first end 112 of the conduit 110 is located on a widened portion 116 of the conduit. The widened portion 116 of the conduit 110 is generally conical and narrows as it extends away from the first end 112 and toward the second end 114 of the conduit. The second end 114 of the conduit 110 is located on a cylindrical portion 120 of the conduit. The cylindrical portion 120 of the conduit 110 extends between the widened portion 116 and the second end 114 of the conduit. The cylindrical portion 120 is centered on axis A. The conduit 110 also includes inner and outer circumferential surfaces 122 and 124, respectively.

The first end 112 of the conduit 110 is fixedly attached to the second side surface 44 of the igniter endcap 24. Preferably, the first end 112 of the conduit 110 is welded to the second side surface 44 of the igniter endcap 24. When the first end 112 is attached to the second side surface 44 of the igniter endcap 24, the widened portion 116 of the conduit 110 surrounds the circular opening 52 that is located on the second side surface 44 of the igniter endcap 24. The conduit 110 extends axially away from the igniter endcap 24 and through approximately eighty percent of the axial length of the chamber 70. The second end 114 of the conduit 110 is centered on axis A and is spaced away from the diffuser endcap 26.

As shown in FIG. 1, the conduit 110 divides the chamber 70 into three chamber portions 130, 132, and 134. The inner surface 122 of the conduit 110 defines chamber portion 130. Chamber portion 130 is located within the conduit 110 and has an axial length equal to the axial length of the conduit. Chamber portion 132 is defined between the outer surface 124 of the conduit 110 and the inner surface 30 of the body portion 22 of the container 12. Chamber portion 132 is generally annular and has an axial length equal to the axial length of the conduit 110. Chamber portion 134 extends axially between the end 114 of the conduit 110 and the first side surface 60 of the diffuser endcap 26. The inner surface 30 of the body portion 22 of the container 12 defines the radially outer extent of chamber portion 134.

The inflator 10 of the present invention is actuatable for providing inflation fluid having a low concentration of the combustible gas mixture 80. To actuate the inflator 10, an electrical signal is sent to the igniter 82. When the igniter 82 receives the electrical signal, the igniter 82 is actuated, i.e., the pyrotechnic material of the actuatable portion 84 of the igniter 82 is ignited.

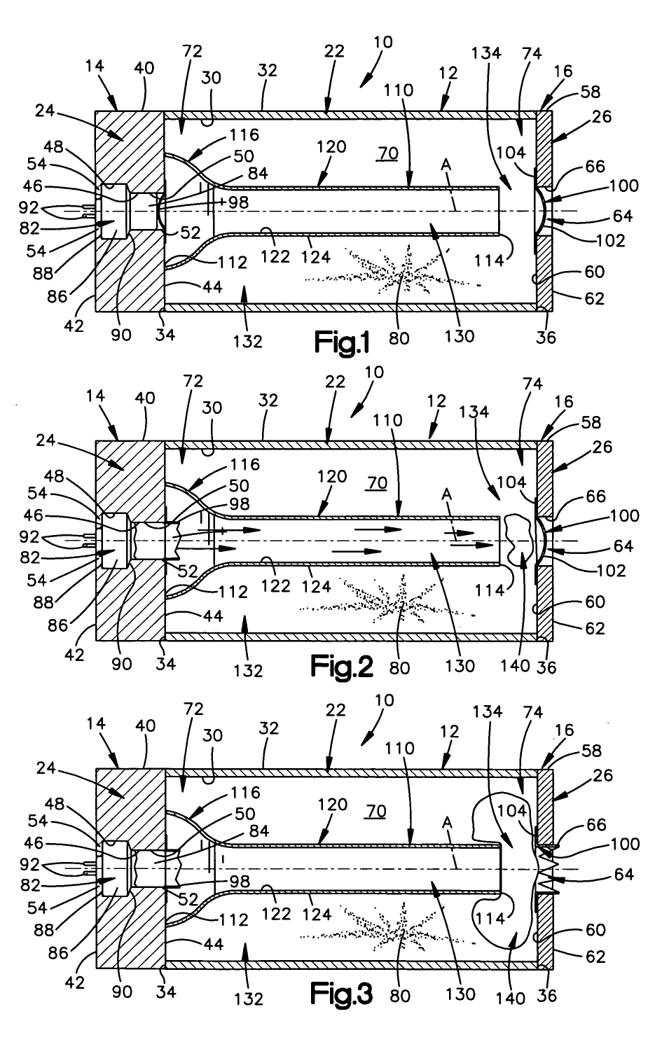

FIG. 2 illustrates the inflator 10 shortly after actuation of the igniter 82 and prior to rupturing of the burst disk 100. When the igniter 82 is actuated, the burst disk 98 is ruptured and the combustible gas mixture 80 located within the conduit 110, i.e., within chamber portion 130, and adjacent to the igniter 82 is ignited. A burn front (not shown) moves through the conduit 110 and exits the second end 114 of the conduit. Arrows in FIG. 2 illustrate movement of the burn front through the conduit 110, i.e., through chamber portion 130. The burn front exits the conduit 110 and forms a heating zone, indicated generally at 140, in chamber portion 134 of the chamber 70. The combustible gas mixture 80 is heated beyond the predetermined temperature in the heating zone 140 and inflation fluid is formed. The formation of inflation fluid resulting from combustion of the combustible gas mixture 80 with the chamber portions 130 and 134 increases the pressure within the chamber 70 beyond the predetermined amount necessary to rupture the burst disk 100. As a result of the increase pressure, the burst disk 100 is ruptured and inflation fluid begins to exit the inflator 10 through the exit passage 64.

FIG. 3 illustrates the inflator 10 in an actuated condition with the burst disk 100 ruptured. When the burst disk 100 is ruptured, the combustible gas mixture 80 within the chamber 70 tends to flow toward the exit passage 64 to exit the chamber. The heating zone 140 produced by actuation of the igniter 82 is located within chamber portion 134 and in a flow path between chamber portion 132 and the exit passage 64. The combustible gas mixture 80 that is located within chamber portion 132 of the chamber 70 passes through the heating zone 140 prior to exiting the inflator 10 through the exit passage 64. As a result, the combustible gas mixture 80 of chamber portion 132 is heated beyond the predetermined temperature and experiences combustion prior to exiting the inflator 10 through the exit passage 64.

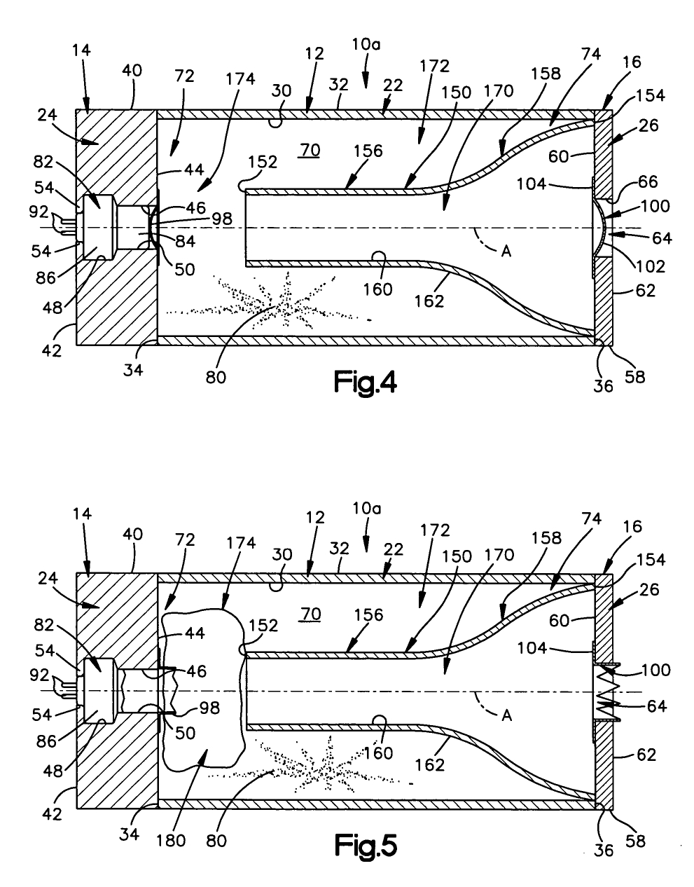

FIG. 4 illustrates a sectional view of an inflator 10a constructed in accordance with a second embodiment of the present invention. The inflator 10a of FIG. 4 is in a non-actuated condition. Structures of the inflator 10a of FIG. 4 that are the same as or similar to structures of the inflator 10 of FIG. 1 are indicated using the same reference numbers.

The inflator 10a of FIG. 4 is identical to the inflator 10 of FIG. 1 with the exception of the structure and location of the conduit, indicated at 150 in FIG. 4. The conduit 150 is located within the chamber 70 of the container 12 and is axially elongated and generally tubular. The conduit 150 includes opposite first and second ends 152 and 154, respectively. The first end 152 of the conduit 150 is located on a cylindrical portion 156 of the conduit. The cylindrical portion 156 of the conduit 150 extends between the first end 152 and a widened portion 158 of the conduit. The cylindrical portion 156 is centered on axis A. The widened portion 158 of the conduit 150 is generally conical and widens as it extends from the cylindrical portion 156 toward the second end 154. The widened portion 158 terminates at the second end 154 of the conduit 150. The conduit 150 also includes inner and outer circumferential surfaces 160 and 162, respectively.

The first end 152 of the conduit 150 is located within the chamber 70 in a location axially spaced away from the second side surface 44 of the igniter endcap 24. The second end 154 of the conduit 150 is fixedly attached to the first side surface 60 of the diffuser endcap 26. Preferably, the second end 154 of the conduit 150 is welded to the first side surface 60 of the diffuser endcap 26. Alternatively, the second end 154 of the conduit 150 may have a diameter that is approximately equal to the diameter of the inner surface 30 of the body portion 22 and may be fixed to the inner surface at a location adjacent the first side surface 60 of the diffuser endcap 26. The widened portion 158 of the conduit 150 surrounds the circular opening that leads to the exit passage 64. The conduit 150 extends axially away from the diffuser endcap 26 and through approximately eighty percent of the axial length of the chamber 70.

As shown in FIG. 4, the conduit 150 divides the chamber 70 into three chamber portions 170, 172, and 174. The inner surface 160 of the conduit 150 defines chamber portion 170. Chamber portion 170 is located within the conduit 150 and has an axial length equal to the axial length of the conduit. Chamber portion 172 is defined between the outer surface 162 of the conduit 150 and the inner surface 30 of the body portion 22 of the container 12. Chamber portion 172 is generally annular and has an axial length equal to the axial length of the conduit 150. Chamber portion 174 extends axially between the second side surface 44 of the igniter endcap 24 and the first end 152 of the conduit 150. The inner surface 30 of the body portion 22 of the container 12 defines the radially outer extent of chamber portion 174.

The inflator 10a is also actuatable for providing inflation fluid having a low concentration of the combustible gas mixture 80. To actuate the inflator 10a, an electrical signal is sent to the igniter 82. When the igniter 82 receives the electrical signal, the igniter 82 is actuated, i.e., the pyrotechnic material of the actuatable portion 84 of the igniter 82 is ignited. FIG. 4 illustrates the inflator 10a prior to actuation, and FIG. 5 illustrates the inflator 10a after actuation and after rupturing of the burst disks 98 and 100.

When the igniter 82 is actuated, the combustible gas mixture 80 located adjacent the igniter 82, i.e., within chamber portion 174, is ignited. A heating zone, indicated generally at 180 in FIG. 5, is produced in chamber portion 174. The formation of inflation fluid resulting from combustion of the combustible gas mixture 80 with chamber portion 174 increases the pressure within the chamber 70 beyond the predetermined amount necessary to rupture the burst disk 100. As a result of the increase pressure, the burst disk 100 is ruptured and inflation fluid begins to exit the inflator 10a through chamber portion 170 and the exit passage 64.

The heating zone 180 in chamber portion 174 is located in a flow path between chamber portion 172 and the exit passage 64. The combustible gas mixture 80 that is located within chamber portion 172 of the chamber 70 passes through the heating zone 180 prior to exiting the inflator 10a through chamber portion 170 and the exit passage 64. As a result, the combustible gas mixture 80 of chamber portion 172 is heated beyond the predetermined temperature and is combusted prior to exiting the chamber 70.

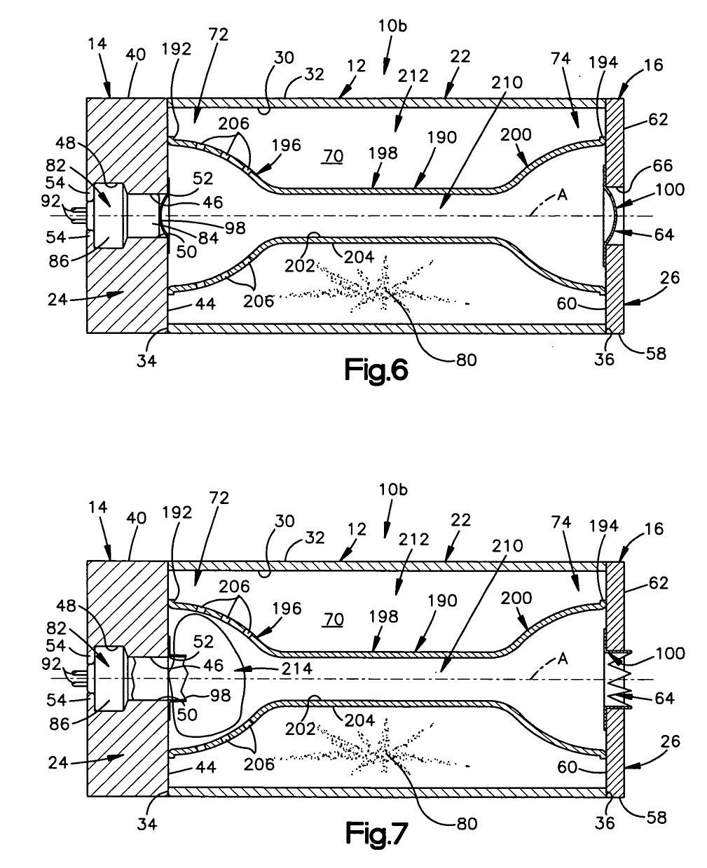

FIG. 6 illustrates a sectional view of an inflator 10b constructed in accordance with a third embodiment of the present invention. The inflator 10b of FIG. 6 is in a non-actuated condition. Structures of the inflator 10b of FIG. 6 that are the same as or similar to structures of the inflator 10 of FIG. 1 are indicated using the same reference numbers.

The inflator 10b of FIG. 6 is identical to the inflator 10 of FIG. 1 with the exception of the structure and location of the conduit, indicated at 190 in FIG. 6. The conduit 190 is located within the chamber 70 of the container 12 and is axially elongated and generally tubular. The conduit 190 includes opposite first and second ends 192 and 194, respectively. The first end 192 of the conduit 190 is located on a first widened portion 196 of the conduit. The first widened portion 196 of the conduit 190 is generally conical and narrows as it extends away from the first end 192 and toward the second end 194 of the conduit. The first widened portion 196 of the conduit 190 terminates at a cylindrical portion 198 of the conduit 190. The cylindrical portion 198 of the conduit 190 extends between the first widened portion 196 and a second widened portion 200 of the conduit. The cylindrical portion 198 is centered on axis A. The second widened portion 200 of the conduit 190 is generally conical and widens as it extends away from the cylindrical portion 198 and toward the second end 194. The second widened portion 200 terminates at the second end 194 of the conduit 190. The conduit 190 also includes inner and outer circumferential surfaces 202 and 204, respectively.

The conduit 190 has an axial length that is equal to the axial length of the chamber 70. The first end 192 of the conduit 190 fixed to the second side surface 44 of the igniter endcap 24. Preferably, the first end 192 of the conduit 190 is welded to the second side surface 44 of the igniter endcap 24. The first widened portion 196 of the conduit 190 surrounds the circular opening 52 on the second side surface 44 of the igniter endcap 24. The first widened portion 196 of the conduit 190 includes a plurality of fluid flow passages 206. The fluid flow passages 206 extend through the first widened portion 196 from the inner surface 202 to the outer surface 204. The fluid flow passages 206 enable fluid flow into and out of the conduit 190.

The second end 194 of the conduit 190 is fixed to the first side surface 60 of the diffuser endcap 26. Preferably, the second end 154 of the conduit 190 is welded to the first side surface 60 of the diffuser endcap 26. The second widened portion 200 of the conduit 190 surrounds the circular opening that leads to the exit passage 64.

As shown in FIG. 6, the conduit 190 divides the chamber 70 into two chamber portions 210 and 212. The inner surface 202 of the conduit 190 defines chamber portion 210. Chamber portion 210 is located within the conduit 190. Chamber portion 212 is generally annular and is defined between the outer surface 204 of the conduit 190 and the inner surface 30 of the body portion 22 of the container 12.

The inflator 10b is actuatable for providing inflation fluid having a low concentration of the combustible gas mixture 80. To actuate the inflator 10b, an electrical signal is sent to the igniter 82. When the igniter 82 receives the electrical signal, the igniter 82 is actuated, i.e., the pyrotechnic material of the actuatable portion 84 of the igniter 82 is ignited. FIG. 6 illustrates the inflator 10b prior to actuation, and FIG. 7 illustrates the inflator 10b after actuation and rupturing of the burst disks 98 and 100.

When the igniter 82 is actuated, the combustible gas mixture 80 located adjacent the igniter and within chamber portion 210 is ignited. A heating zone, indicated generally at 214 in FIG. 7, is produced in chamber portion 210. The heating zone 214 heats the combustible gas mixture 80 beyond the predetermined temperature at which the combustible gas mixture experiences combustion and inflation fluid is formed. The formation of inflation fluid resulting from combustion of the combustible gas mixture 80 with chamber portion 210 increases the pressure within the chamber 70 beyond the predetermined amount necessary to rupture the burst disk 100. As a result of the increase pressure, the burst disk 100 is ruptured and inflation fluid begins to exit the inflator 10b through chamber portion 210 and the exit passage 64.

The heating zone 214 in chamber portion 210 is located in a flow path between chamber portion 212 and the exit passage 64. The combustible gas mixture 80 that is located within chamber portion 212 of the chamber 70 passes through the heating zone 214 prior to exiting the inflator 10b through chamber portion 210 and the exit passage 64. As a result, the combustible gas mixture 80 of chamber portion 212, when passing through the heating zone 214, is heated beyond the predetermined temperature and is combusted prior to exiting the chamber 70.

From the above description of the invention, those skilled in the art will perceive improvements, changes and modifications. Such improvements, changes and modifications within the skill of the art are intended to be covered by the appended claims.

Having described the invention, we claim the following:

1. An inflator comprising:
a container having a fluid storage chamber and an exit passage;
a fluid stored in the chamber, the fluid, when heated beyond a predetermined temperature, undergoing one of combustion, thermal decomposition, or a change of state to result in inflation fluid;
an igniter for, when actuated, heating the fluid beyond the predetermined temperature; and
structure within the chamber for limiting the flow of the fluid through the exit passage of the container prior to being heated beyond the predetermined temperature.

2. The inflator of claim 1 wherein the fluid is a combustible gas mixture that, when heated beyond the predetermined temperature, is combusted.

3. The inflator of claim 1 wherein the structure divides the chamber into first and second chamber portions, the second chamber portion being located in a flow path between the first chamber portion and the exit passage, actuation of the igniter producing a heating zone in the second chamber portion so that the fluid within the first chamber portion passes through the heating zone prior to exiting the chamber through the exit passage.

4. The inflator of claim 3 wherein the structure extends axially within the chamber, the first chamber portion being located radially adjacent the structure and the second chamber portion being located axially adjacent an end of the structure.

5. The inflator of claim 3 wherein the structure is a conduit.

6. The inflator of claim 5 wherein an inner surface of the conduit defines a third chamber portion, the third chamber portion being located between the igniter and the second chamber portion, heat resulting from actuation of the igniter passing through the third chamber portion prior to producing the heating zone in the second chamber portion.

7. The inflator of claim 5 wherein an inner surface of the conduit defines a third chamber portion, the third chamber portion being located between the second chamber portion and the exit passage, inflation fluid resulting from heating the fluid of the first chamber portion passing through the third chamber portion prior to exiting the chamber through the exit passage.

8. The inflator of claim 5 wherein the conduit includes axially opposite first and second ends, the first end of the conduit surrounding an opening of the container that is associated with the igniter and the second end of the conduit surrounding an opening of the container that is associated with the exit passage, the first end of the conduit including at least one fluid flow passage, the second chamber portion being located within the conduit, the at least one fluid flow passage providing fluid communication between the first chamber portion and the second chamber portion.

9. An inflator comprising:
a container having a fluid storage chamber, the chamber including opposite first and second ends;
an exit passage located at the second end of the container;
a fluid stored in the chamber, the fluid, when heated beyond a predetermined temperature, undergoing one of combustion, thermal decomposition, or a change of state to result in inflation fluid;
structure within the chamber for limiting the flow of the fluid through the exit passage of the container prior to being heated beyond the predetermined temperature, the structure including first and second ends, the first end of the structure being connected with the container, the structure dividing the chamber into first and second chamber portions, the second chamber portion being located in a flow path between the first chamber portion and the exit passage; and
an igniter for, when actuated, producing a heating zone in the second chamber portion, the fluid passing through the heating zone being heated beyond the predetermined temperature,
fluid within the first chamber portion passing through the heating zone prior to exiting the chamber through the exit passage.

10. The inflator of claim 9 wherein the first end of the structure is connected to the container at the second end of the chamber, the flow path between the first chamber portion and the exit passage extending through the first end of the chamber.

11. The inflator of claim 9 wherein the first end of the structure is connected to the container at the first end of the chamber and the second end of the structure is connected to the container at the second end of the chamber, the first end of the structure including at least one fluid flow passage through which the flow path between the first chamber portion and the exit passage extends.

12. The inflator of claim 9 wherein the structure is a conduit.

13. The inflator of claim 12 wherein the first end of the conduit surrounds an opening of the container that is associated with the exit passage.

14. The inflator of claim 9 wherein the first end of the conduit surrounds an opening of the container that is associated with the igniter and the second end of the conduit surrounds an opening of the container that is associated with the exit passage, the second chamber portion being located within the conduit, at least one fluid flow passage being located in the first end of the conduit, the at least one fluid flow passage providing fluid communication between the first chamber portion and the second chamber portion.

15. The inflator of claim 12 wherein the first end of the conduit surrounds an opening of the container that is associated with the igniter and an inner surface of the conduit defines a third chamber portion, heat produced by actuation of the igniter passing through the third chamber portion prior to producing the heating zone in the second chamber portion.
